(19) United States
(12) Patent Application Publication
(10) Pub. No.: US 2004/0249686 A1
(43) Pub. Date: Dec. 9, 2004

(54) Method and computer program for generating interactive map-based presentation facilitating selection of lodging property

(76) Inventor: Steven Linn Murphy, Atlanta, GA (US)

Correspondence Address: Hovey Williams LLP, Suite 400, 2405 Grand Blvd., Kansas City, MO, 64108, US

(21) Appl. No.: 10/667,677

(22) Filed: Sep. 22, 2003

Related U.S. Application Data
(60) Provisional application No. 60/475,571, filed on Jun. 3, 2003.

(51) Int. Cl. G06F 17/60

(52) U.S. Cl. 705/5; 701/208

(57) ABSTRACT

A method and computer program adapted to generate an interactive map-based presentation that combines static descriptive information; real-time access to dynamic information such as, for example, availability, rate, and certain policy information; and real-time access to a computerized registration system (70) for one or more lodging properties located within a user-specified geographic area of interest and meeting any other user-specified criteria, and thereby facilitates more efficient and effective selection of a particular lodging property and the making of a reservation thereat. The lodging properties are plotted on an interactive map (54), wherein indicating (e.g., “mousing over”) a particular lodging property causes to appear a pull-down dialog box (62) providing the static and dynamic information (80,82) or links (84,86) thereto.

### RELATED APPLICATIONS

The present application is a nonprovisional patent application and claims priority benefit, with regard to all common subject matter, of an earlier-filed U.S. provisional patent application titled “METHOD AND COMPUTER PROGRAM FOR INTERACTIVE HOTEL MAPPING”, Serial No. 60/475,571, filed Jun. 3, 2003. The identified earlier-filed application is hereby incorporated by reference into the present application.

### BACKGROUND OF THE INVENTION

1. Field of the Invention

The present invention relates broadly to methods and computer programs for communicating information concerning one or more hotels, motels, inns, or other lodging properties. More particularly, the present invention relates to a method and computer program adapted to generate an interactive map-based presentation that combines static descriptive information; real-time access to dynamic information such as, for example, availability, rate, and policy information; and real-time access to a computerized registration system for one or more lodging properties located within a user-specified geographic area of interest and meeting any other user-specified criteria. The invention facilitates more efficient and effective selection of a particular lodging property and the making of a reservation thereat.

2. Description of the Prior Art

Travelers often desire to research lodging options prior to making a reservation with or otherwise committing to a particular hotel, motel, inn, or other lodging property. Often, the most important factors considered by consumers when making a lodging decision are location, availability, and rates. A great deal of such information is now available via the World Wide Web (WWW), and many lodging properties maintain a website or other web-presence.

Most web-based search engines, for example, will return a text-based listing of lodging properties that meet one or more user-specified criteria. The text-based list will also typically include hyperlinks to separate websites or webpages for additional information. Unfortunately, accessing and downloading this information for each lodging property of interest can be extremely tedious and time-consuming, particularly when using a relatively slow network connection. Furthermore, the information will likely include only static or relatively unchanging descriptive information, with no indication of current availability, rates, policies, or other dynamic information subject to frequent change. Where such dynamic information can be accessed, it is typically provided on separate websites or webpages that, as mentioned, require additional tedious and time-consuming downloading. Also, though the text-based list may provide street addresses for the various lodging properties, this alone imparts no useful understanding of the lodging properties' locations relative to each other or to other locations of interest.

Prior art web-based tools are also available that plot lodging properties on virtual maps in response to the user's identification of a geographic area of interest. Unfortunately, these tools still require that the user separately link to other websites or webpages in order to access additional information. Furthermore, these tools typically provide only static databased information such as names, street addresses, and types or classifications of the lodging properties. Where availability or rate information is provided, it is typically in the form of batches of inventory and is updated no more often than two or three times each day. It will be appreciated that infrequent updating of time-sensitive, frequently changing dynamic information provides little or no advantage and may lead to confusion and unfortunate misunderstandings. Thus, as a practical matter, these prior art tools only supplement or provide minor improvement over text-based listings.

Having to access multiple separate websites or webpages for additional information can create substantial obstacles both to use and effectiveness. For example, accessing lodging information via the Internet from some of the world's largest travel-related websites requires, on average, six “clicks-to-book”, wherein clicks-to-book is the number of screens a user must pass through before being allowed to make a reservation at a lodging property. Unfortunately, for each additional required click over two, an additional 50% of users are likely to stop searching and not make a reservation. Thus, for example, only 6.25% of users who begin searching will likely remain to reserve a room after six required clicks.

Due to the above-identified and other problems and disadvantages in the prior art, a need exists for an improved method of providing lodging information.

### SUMMARY OF THE INVENTION

The present invention overcomes the above-described and other problems and disadvantages in the prior art by providing a method and computer program adapted to generate an interactive map-based presentation that combines static descriptive information; real-time access to dynamic information such as, for example, availability, rate, and policy information; and real-time access to a computerized reservation system (CRS) for one or more hotels, motels, inns or other lodging properties located within a user-specified geographic area of interest and meeting any other user-specified criteria, and thereby facilitates more efficient and effective selection of a particular lodging property and the making of a reservation thereat.

The present invention may be implemented using a system to store and execute some or all of a computer program or combination of code segments, information sources, and other software to generate a website or webpage. The system broadly comprises a first computing device operable to store or access and execute some or all of the aforementioned code segments, information sources, and other software, and to host the website or webpage to be accessed via the Internet by a user with a user's computing device. The system may further include a second computing device maintained by a third-party service provider and operable to store and execute map-generating software, and at least one third computing device maintained by a fourth-party and operable to store and execute a CRS.

The computer program broadly comprises a code segment for receiving user input; map-generating software for generating a map; a code segment for filtering data; a code segment for plotting locations; a code segment for generating a pull-down dialog box; a database of static descriptive information; a code segment for accessing dynamic information; and an interface for interacting with one or more CRSs. The code segment for receiving user input is operable to receive input data from the user via a pointing device or keyboard regarding a city, region, location, or other geographic area of interest or a natural or artificial feature or attraction that can be associated with an area of interest, as well as any other user-specified criteria on which the user desires to base his or her lodging decision. The user-specified area of interest and any other user-specified criteria relevant to mapping are provided to the map-generating software; all other user-specified criteria are provided to the code segment for filtering data.

The map-generating software is operable to produce the virtual or electronic map of the area specified by the user. The resulting map is provided to the code segment for plotting locations. The code segment for filtering data is operable to eliminate any non-conforming lodging properties identified as being within the area of interest but not meeting or conforming to all other user-specified criteria. The filtered data is provided to the code segment for plotting locations. The code segment for plotting locations is operable to plot the locations of the conforming lodging properties and any user-specified features or attractions of interest on the map produced by the map-generating software.

The code segment for generating a pull-down dialog box is operable to generate a pull-down dialog box in response to the user's indication (e.g., “mousing over”) or selection of a particular plotted lodging property plotted using the pointing device. The pull-down dialog box is associated with the same webpage as the map, thereby avoiding the inconvenience of having to download additional webpages. The dialog box preferably includes both static information and dynamic information or links thereto.

The database of static descriptive information contains relatively unchanging, infrequently changing, or otherwise static descriptive information for the lodging properties. The static information may include, for example, street addresses, telephone numbers, fax numbers, and email addresses; special features or amenities (e.g., swimming pool, Internet access, handicap accessible, pet friendly, restaurant on premises); ratings; reviews; photographs; and interactive video tours. The code segment to access and display dynamic information is operable to access and display in substantially real-time time-sensitive, frequently changing, or otherwise dynamic information such as, for example, availability, rates, and certain policies.

The interface allows for interacting with the CRSs, particularly with regard to making reservations therewith. The interface may access the CRSs using a substantially realtime hardwired or wireless connection.

Thus, it will be appreciated that the present invention provides a number of substantial advantages over the prior art, including, for example, greatly enhancing the user's experience and increasing user retention by providing substantially all information necessary or desirable to making a lodging decision on a single webpage in order to minimize the total number of clicks required to access the information and make a reservation. Furthermore, once the information is downloaded it is thereafter substantially accessible at will, whereas a user of the prior art must re-link to the separate webpages each time he or she desires to re-read or review the data. Additionally, time-sensitive or frequently changing information is provided in real-time or nearly so, thereby assuring that users receive and base their lodging decisions on correct and up-to-date information. Thus, the present invention advantageously allows users to shop for suitable lodging properties in a more efficient and more effective manner.

These and other important features of the present invention are more fully described in the section titled DETAILED DESCRIPTION OF A PREFERRED EMBODIMENT, below.

### BRIEF DESCRIPTION OF THE DRAWINGS

A preferred embodiment of the present invention is described in detail below with reference to the attached drawing figures, wherein:

FIG. 1 is a diagram of a system used in implementing a preferred embodiment of the present invention;

FIG. 2 is a block diagram of code segments, information sources, and other software stored on or accessed and executed by the system of FIG. 1 to implement a preferred embodiment of the present invention;

FIG. 3 is an illustration of a webpage hosted on the system of FIG. 1 and generated by the code segments, information sources, and other software shown in FIG. 2;

FIG. 4 is a flow diagram of a series of steps involved in practicing the preferred embodiment of the present invention; and

FIG. 5 is a flow diagram of an alternate series of steps involved in practicing the preferred embodiment of the present invention.

### DETAILED DESCRIPTION OF A PREFERRED EMBODIMENT

With reference to the figures, a method and computer program are herein described, shown, and otherwise disclosed in accordance with a preferred embodiment of the present invention. Broadly, the present invention provides an interactive map-based presentation that combines static descriptive information; real-time access to dynamic information such as, for example, availability, rate, and policy information; and real-time access to a CRS for one or more hotels, motels, inns or other lodging properties located within a user-specified geographic area of interest and meeting any other user-specified criteria, and thereby facilitates more efficient and effective selection of a particular lodging property and the making of a reservation thereat.

Advantageously, the present invention greatly enhances the user's experience and increases user retention by providing substantially all information necessary or desirable to making a lodging decision on a single webpage in order to minimize the total number of clicks required to access the information and make a reservation. Furthermore, once the information is downloaded it is thereafter substantially accessible at will and as desired, whereas a user of the prior art must re-link to the separate webpages each time he or she desires to re-read or review the data. Additionally, time-sensitive, frequently changing, or otherwise dynamic information is provided in substantially real-time, thereby assuring that users receive and base their lodging decisions on correct and up-to-date information. Thus, the present invention advantageously allows users to shop for suitable lodging properties more efficiently and more effectively.

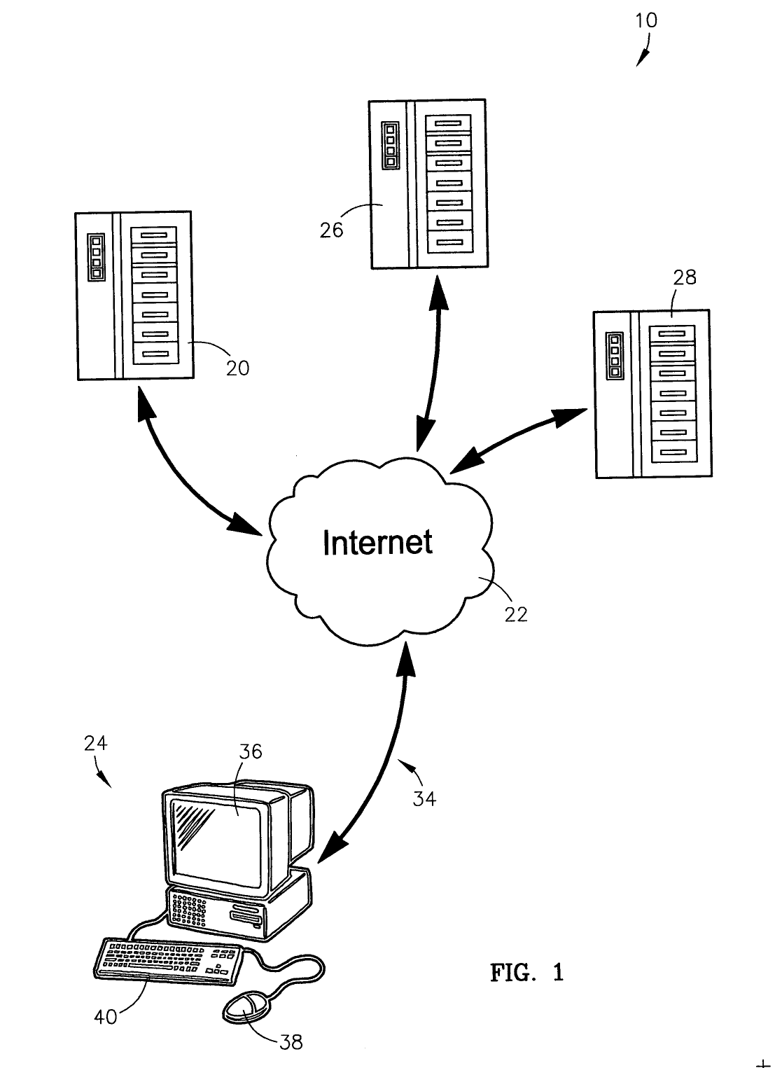

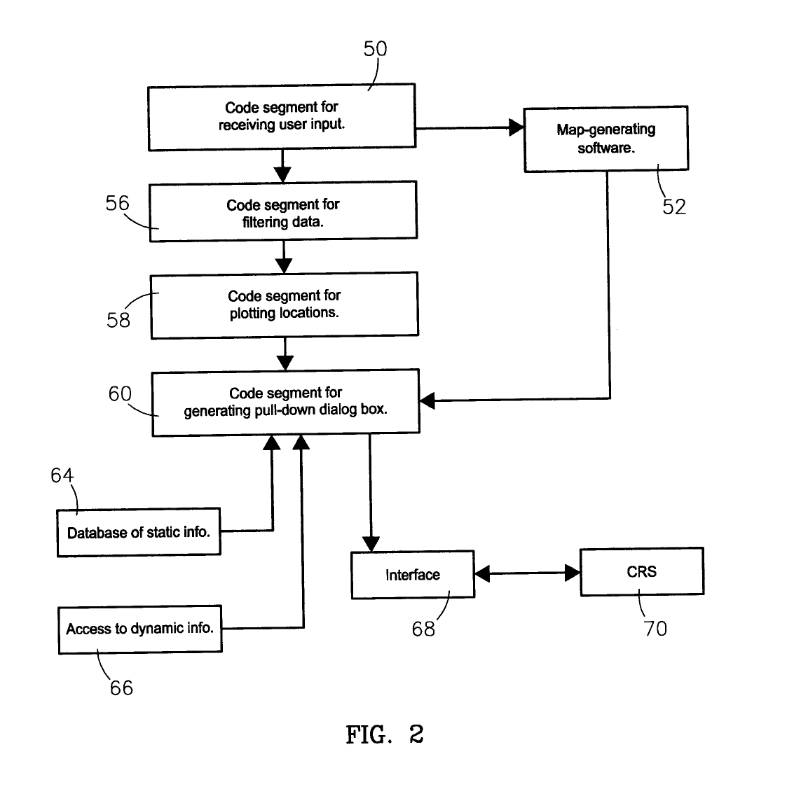

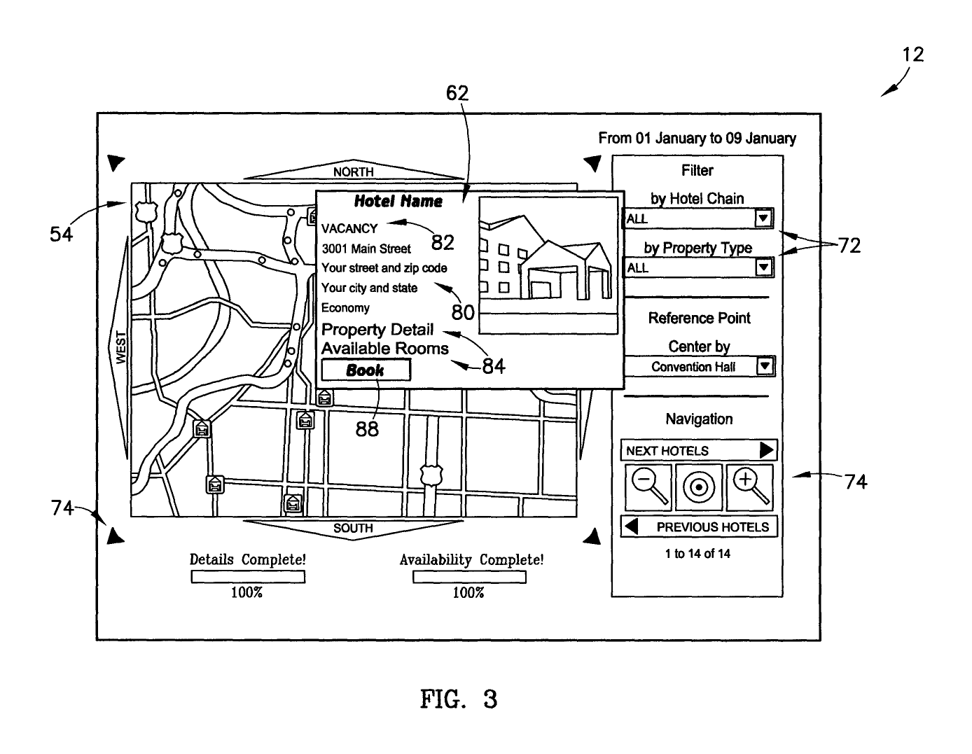

The present invention may be implemented using a system 10, an example of which is shown in FIG. 1, to a store and execute some or all of a computer program or combination of code segments, information sources, and other software, an example of which is shown in FIG. 2, to generate a website or webpage 12, an example of which is shown in FIG. 3. The system 10 broadly comprises a first computing device 20 operable to store or access and execute some or all of the aforementioned code segments, information sources, and other software, and to host the website or webpage 12. The first computing device 20 may be, for example, a conventional server operable to access a network such as the Internet 22 and communicate therethrough with a user's computing device 24. As illustrated, the system 10 may further include a second computing device 26 maintained by a third-party service provider and operable to store and execute map-generating software and to provide a map to the first computing device 20, as discussed below, and at least one third computing device 28 maintained by a fourth-party and operable to store and execute a CRS, as discussed below.

The user's computing device 24 may include a network connection 34; a display 36; a pointing device 38; and a keyboard 40. The network connection 34 may be any conventional hardwired or wireless network connection operable to allow the user to access the webpage 12 via the Internet or other network. The display 36 may be any conventional computer monitor, screen, or other display operable to display or otherwise communicate the interactive presentation generated by the system and appearing on the webpage 12. The pointing device 38 may be any conventional pointing device (e.g., computer mouse, stylus, touchpad, touchscreen) operable to allow the user to indicate or otherwise select a lodging property plotted in the interactive presentation. The keyboard 40 may be any conventional alphanumeric keyboard operable to allow the user to input the user-specified criteria and any information required by the CRSs for making a reservation. In one contemplated implementation, the keyboard 40 is a virtual keyboard displayed on the display 36, wherein virtual keys are selected using the pointing device 38. These components and capabilities may be provided in the form of, for example, a conventional desktop or portable personal computer, hand-held computing device, or cellular telephone.

The computer program broadly comprises a code segment 50 for receiving user input; map-generating software 52 for generating a map 54; a code segment 56 for filtering data; a code segment 58 for plotting locations; a code segment 60 for generating a pull-down dialog box 62; a database 64 of static descriptive information; a code segment 66 for accessing dynamic information; and an interface 68 for interacting with one or more CRSs 70.

The code segment 50 for receiving user input is operable to receive input data from the user via the pointing device 38 or keyboard 40 regarding a city, region, location, or other geographic area of interest or a natural or artificial feature or attraction that can be associated with an area of interest (the Lincoln Memorial, for example, can be associated with a particular area within Washington, D.C.), as well as any other user-specified criteria on which the user desires to base his or her lodging decision. The user may, for example, identify one or more features or attractions of interest (e.g., museums, theaters, convention centers, memorials, stadiums) near which he or she wishes to be lodged. Other possible user-specified criteria may include, for example, a particular chain or type of lodging property, a particular feature or amenity, or a particular rate or range of rates. In one contemplated implementation, some user-criteria, such as, for example, lodging chain or property type, may be selectable from one or more pull-down menus 72 to make the user's input of this data more convenient. The user-specified area of interest and any other user-specified criteria relevant to mapping are provided to the map-generating software 52; all other user-specified criteria are provided to the code segment 56 for filtering data.

The map-generating software 52 is operable to produce the virtual or electronic map 54 of the area specified by the user. The webpage 12 preferably provides navigation controls 74 allowing the user to, for example, zoom in; zoom out; center the map on a more specific area, feature, or attraction of interest; or view other geographic areas adjacent to the originally-specified area of interest. In one contemplated implementation of the present invention, the map-generating software 52 is owned and maintained by a third-party service provider and accessed via a hardwired or wireless network connection. The resulting map 54 is provided to the code segment 58 for plotting locations.

The code segment 56 for filtering data is operable to eliminate any non-conforming lodging properties identified as being within the area of interest but not meeting or conforming to all other user-specified criteria. Though possible to identify all lodging properties within the area of interest, this may be cumbersome or impractical, particularly for densely populated areas having a great many lodging properties. Thus, the code segment 56 for filtering data reduces the number of plotted lodging properties to a manageable level. The filtered data is provided to the code segment 58 for plotting locations.

The code segment 58 for plotting locations is operable to plot the locations of the conforming lodging properties and any user-specified features or attractions of interest on the map 54 produced by the map-generating software 52. The locations are available to the code segment 58 in the form of latitudes and longitudes. Preferably, a geographic center point of the area of interest is determined based upon an average latitude and an average longitude of the one or more plotted lodging properties, and the map 54 is initially displayed centered upon this center point. Specific pixels corresponding to the plotted lodging properties are also determined or provided in order to define borders for the code segment 60 for generating a pull-down dialog box. In one contemplated implementation, the plotted lodging properties and features or attractions of interest are identified on the map 54 using distinctive or easily recognizable symbols, icons, or other identifiers.

The code segment 60 for generating a pull-down dialog box is operable to generate the pull-down dialog box 62 in response to the user's indication (e.g., “mousing over”) or selection of a particular plotted lodging property plotted using the pointing device 38 of the user's computing device 24. Accessing the pull-down dialog box 62 requires no clicking; instead, the pull-down dialog box 62 substantially automatically appears and disappears whenever the user physically passes over or causes a virtual pointer to pass over a plotted lodging property. Thus, the pull-down dialog box 62 is associated with the same webpage 12 as the map 54, thereby avoiding the inconvenience of having to download additional webpages. The dialog box 62 preferably includes both static information 80 and dynamic information 82 or links 84,86 thereto, as discussed below.

The database 64 of static descriptive information contains relatively unchanging, infrequently changing, or otherwise static descriptive information for the lodging properties. The static information may include, for example, street addresses, telephone numbers, fax numbers, and email addresses; special features or amenities (e.g., swimming pool, Internet access, handicap accessible, pet friendly, restaurant on premises); ratings; reviews; photographs; and interactive video tours. As mentioned, some 80 or all of this static information may appear in the pull-down dialog box 62, and the aforementioned link 84 may be provided for accessing any of the static information not appearing in the pull-down dialog box 62. It will be appreciated that only the static descriptive information may needs be cached or otherwise stored for potentially long periods of time, with the dynamic information not being cached or stored but rather accessed in substantially real-time.

The code segment 66 to access and display dynamic information is operable to access and display in substantially real-time time-sensitive, frequently changing, or otherwise dynamic information such as, for example, availability, rates, and certain policies, in response to the user's indication (e.g., “mousing over”) or selection of a particular plotted lodging property. Some or all of the dynamic information may be provided by the CRSs 70 of the lodging properties. As mentioned, some 82 or all of the dynamic information may appear in the pull-down dialog box 62, and the aforementioned link 86 may be provided for accessing any of the dynamic information not appearing in the pull-down dialog box 62.

The interface 68 allows for interacting with the CRSs 70, particularly with regard to making reservations therewith. The interface 68 may access the CRSs 70 using a substantially realtime hardwired or wireless connection. A link 88 appearing in the pull-down dialog box 62 leads to or causes to appear the interface 68 for interacting with the particular CRS 70 of the desired lodging property, thereby facilitating the user making a reservation thereat.

As mentioned, the various aforementioned code segments, information sources, and other software may be part of a larger computer program stored on and executed by the first computing device 20. As desired, any of these elements may be owned or maintained by a practitioner of the present invention or may be remotely accessed from a provider. For example, the map-generating software 52, if not provided by and remotely accessed from a third-party, as is shown in FIG. 1, may be stored on and executed by the first computing device 20, thereby eliminating the third-party provider and the third computing device 26. The computer program, or at least the aforementioned code segments, is preferably sufficiently flexible so as to allow for using, for example, substantially any third-party map providers, CRSs or booking engines able to communicate using XML, and distribution systems.

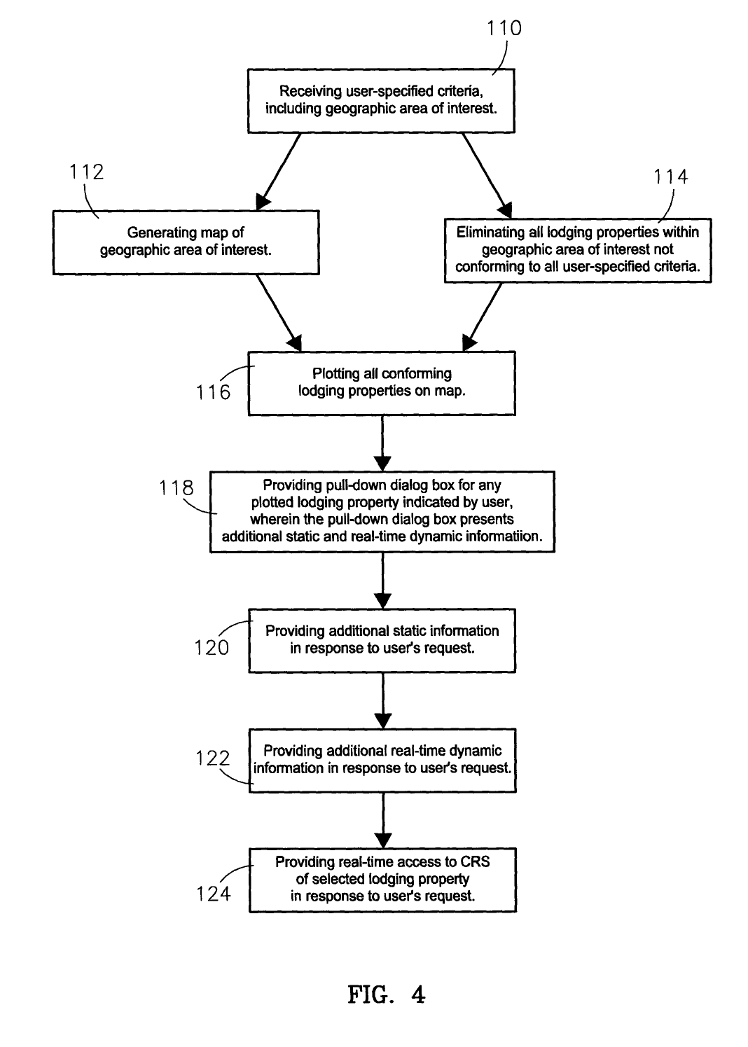

Referring to FIG. 4, exemplary use and operation of the present invention, as implemented using the above-described system 10 and webpage 12, proceeds as follows. The user, planning to travel to a particular geographic area and desiring location and availability information for one or more lodging properties within that geographic area, accesses the website 12 via the network connection 34, causing the website 12 to appear on the display 36.

The user then enters, inputs, or otherwise indicates the city, region, location, or other geographic area of interest or a natural or artificial feature or attraction that can be associated with the geographic area of interest, and any other desired user-specified criteria. As mentioned, these other user-specified criteria may include, for example, a particular chain or type of lodging property, a particular feature or amenity, or a particular rate or range of rates. The user-specified criteria are received by the code segment 50 for receiving user input, as depicted in box 110. The user-specified geographic area of interest and any other user-specified criteria relevant to mapping are provided to the map-generating software 52; all other user-specified criteria are provided to the code segment 56 for filtering data.

Given the user-specified geographic area, the map-generating software 52 generates the map 54, as depicted in box 112, and provides it to the code segment 58 for plotting locations. Given the other user-specified criteria, the code segment 56 for filtering data eliminates all non-conforming lodging properties within the geographic area of interest, as depicted in box 114, thereby minimizing the number of lodging properties that need be plotted. The remaining conforming lodging properties are sent to the code segment 58 for plotting locations.

The code segment 58 for plotting locations receives the map 54 and the list of conforming lodging properties, retrieves the latitudes and longitudes of these properties and plots them on the map 54, as depicted in box 116. As mentioned, this code segment 58 also determines an average latitude and longitude for the various plotted lodging properties and sets this average as the default center of the map 54. Other features or attractions may also be plotted. Once the lodging properties are plotted, the map 54 is presented to the user.

The user, desiring more detailed information about a particular lodging property located near an attraction the user hopes to visit, uses the pointing device 38 to indicate the particular lodging property. This causes the code segment 60 for generating a pull-down box to generate and display the pull-down dialog box 62, as depicted in box 118, presenting some static and dynamic information 80,82, links 84,86 to additional static and dynamic information, and the link 88 for accessing the interface 68 to the CRS 70 of the particular lodging property. Selecting the link 84 for additional static information, the user is provided with information such as, for example, special features or amenities, ratings, reviews, photographs, and an interactive video tour, as depicted in box 120. Selecting the link 86 for additional dynamic information, the user is provided with information such as, for example, real-time availability, real-time rates, and real-time policies, as depicted in box 122.

Deciding to make a reservation at this lodging property clicks on the corresponding link 88, causing the interface 68 to appear and provide the user with substantially real-time access to the CRS 70 of the lodging property, as depicted in box 124. The user then simply follows any instructions that are given and enters any required information using the keyboard 40.

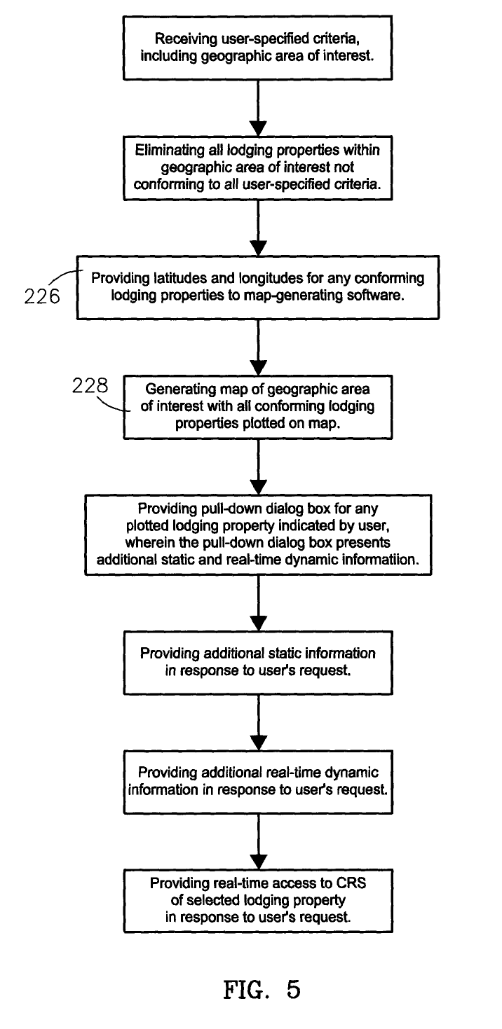

It will be appreciated that a number of the steps involved in implementing and practicing the present invention may take place in an order different from that described above. For example, referring to FIG. 5, in one possible alternative order the method steps proceed as above with the exception that the code segment for plotting locations provides the latitudes and longitudes of the conforming lodging properties to the map generating software 52, as depicted in box 226, and the map 54 is generated with these locations plotted, as depicted in box 228.

As an alternative or in addition to lodging properties, the interactive presentation may display a variety of travel or tourism-related businesses, service providers, or other sites, including, for example, car rental agencies, restaurants; theaters, museums, zoos, major features or attractions, shopping areas, airports, train stations, or other mass transportation sites. The information displayed would depend to some extent on the nature of the site, but could include, for example, menus, showtimes, hours of operation, arrival and departure schedules, real-time availability, or real-time rates, and the user may be provided with access to a substantially real-time reservation or purchase system.

From the preceding description it will be appreciated that the present invention provides a number of substantial advantages over the prior art, including, for example, greatly enhancing the user's experience and increasing user retention by providing substantially all information necessary or desirable to making a lodging decision on a single webpage in order to minimize the total number of clicks required to access the information and make a reservation. Furthermore, once the information is downloaded it is thereafter substantially accessible at will, whereas a user of the prior art must re-link to the separate webpages each time he or she desires to re-read or review the data. Additionally, time-sensitive or frequently changing information is provided in substantially real-time, thereby assuring that users receive and base their lodging decisions on correct and up-to-date information. Thus, the present invention advantageously allows users to shop for suitable lodging properties in a more efficient and effective manner.

Although the invention has been described with reference to the preferred embodiments illustrated in the drawings, it is noted that equivalents may be employed and substitutions made herein without departing from the scope of the invention as recited in the claims. In particular, as mentioned, the steps involved in implementing and practicing the present invention may be reordered as necessary or desired. Also, as mentioned, the map-generating software may be owned and maintained by the practitioner of the present invention or may be provided by and accessed remotely from a third-party provider. Additionally, as mentioned, as an alternative or in addition to lodging properties, the interactive presentation may display a variety of travel or tourism-related businesses, service providers, or other sites, including, for example, car rental agencies, restaurants; theaters, museums, zoos, major features or attractions, shopping areas, airports, train stations, or other mass transportation sites.

Having thus described the preferred embodiment of the invention, what is claimed as new and desired to be protected by Letters Patent includes the following:

1. A method of facilitating selection of a lodging property, the method comprising the steps of:
(a) receiving an indication of a geographic area of interest from a user;
(b) identifying one or more lodging properties located within the geographic area of interest;
(c) displaying a map of the geographic area of interest whereupon are plotted the locations of the one or more lodging properties; and
(d) displaying in a pull-down dialog box substantially dynamic information regarding the particular lodging property indicated by the user, wherein the substantially dynamic information is provided in substantially real-time so as to be substantially current.

2. The method as set forth in claim 1, wherein the indication of the geographic area of interest is in the form of a city name.

3. The method as set forth in claim 1, wherein the indication of the geographic area of interest is in the form of a substantially unique name of a feature having a known location.

4. The method as set forth in claim 1, wherein step (a) includes receiving one or more other user-specified criteria from the user.

5. The method as set forth in claim 4, wherein in step (c) only the locations of one or more conforming lodging properties located within the geographic area of interest and conforming to the one or more other user-specified criteria are plotted on the map.

6. The method as set forth in claim 1, wherein in step (c) the map is initially displayed centered about an average location of the plotted lodging properties.

7. The method as set forth in claim 1, further including the step pfoviding a navigational control allowing the user to manipulate the map for viewing.

8. The method as set forth in claim 7, wherein the navigational control includes a zoom capability and a movement capability.

9. The method as set forth in claim 1, further including the step of displaying in the pull-down dialog box substantially static information regarding a particular lodging property indicated by the user.

10. The method as set forth in claim 7, further including the step of providing one or more hyperlinks to additional static information and additional dynamic information.

11. The method as set forth in claim 1, further including the step of plotting one or more non-lodging features on the map.

12. The method as set forth in claim 1, further including the step of providing substantially real-time access to a computerized reservation system of the particular lodging property indicated by the user so as to facilitate the user making a reservation.

13. A computer program operable to implement the method as set forth in claim 1.

14. A method of facilitating selection of a lodging property, the method comprising the steps of:
(a) receiving an indication of a geographic area of interest and one or more other user-specified criteria from a user;
(b) identifying one or more lodging properties located within the geographic area of interest and conforming to the one or more other user-specified criteria;
(c) displaying a map of the geographic area of interest whereupon are plotted the locations of the one or more lodging properties;
(d) displaying in a pull-down dialog box substantially dynamic information regarding the particular lodging property indicated by the user, wherein the substantially dynamic information is provided in substantially real-time so as to be substantially current; and
(e) providing substantially real-time access to a computerized reservation system of the particular lodging property indicated by the user so as to facilitate the user making a reservation.

15. The method as set forth in claim 14, wherein the indication of the geographic area of interest is in the form of a city name.

16. The method as set forth in claim 14, wherein the indication of the geographic area of interest is in the form of a substantially unique name of a feature having a known location.

17. The method as set forth in claim 14, wherein in step (c) the map is initially displayed centered about an average location of the plotted lodging properties

18. The method as set forth in claim 14, further including the step of providing a navigational control allowing the user to manipulate the map for viewing.

19. The method as set forth in claim 18, wherein the navigational control includes a zoom capability and a movement capability.

20. The method as set forth in claim 14, further including the step of displaying in the pull-down dialog box substantially static information regarding a particular lodging property indicated by the user.

21. The method as set forth in claim 20, further including the step of providing one or more hyperlinks to additional static information and additional dynamic information.

22. The method as set forth in claim 14, further including the step of plotting one or more non-lodging features on the map.

23. A computer program operable to implement the method as set forth in claim 14.

24. A method of facilitating selection of a lodging property, the method comprising the steps of:
(a) receiving an indication of a geographic area of interest and one or more other user-specified criteria from a user;
(b) identifying one or more lodging properties located within the geographic area of interest and conforming to the one or more other user-specified criteria;
(c) displaying a map of the geographic area of interest whereupon are plotted the locations of the one or more conforming lodging properties, wherein the map is initially displayed centered about an average location of the plotted lodging properties;
(d) plotting one or more non-lodging features on the map;
(e) providing a navigational control allowing the user to manipulate the map for viewing, wherein the navigational control includes a zoom capability and a movement capability;
(f) displaying in a pull-down dialog box substantially static information regarding a particular lodging property indicated by the user;
(g) displaying in the pull-down dialog box substantially dynamic information regarding the particular lodging property indicated by the user, wherein the substantially dynamic information is provided in substantially real-time so as to be substantially current;
(h) providing one or more hyperlinks to additional static information and additional dynamic information; and
(i) providing substantially real-time access to a computerized reservation system of the particular lodging property indicated by the user so as to facilitate the user making a reservation

25. A computer program operable to implement the method as set forth in claim 24.

26. A method of facilitating selection of a lodging property, the method comprising the steps of:
(a) receiving a substantially unique name of a feature having a known location, and receiving on or more other user-specified criteria;
(b) identifying one or more lodging properties located within a geographic area associated with the feature and conforming to the one or more other user-specified criteria;
(c) displaying a map of the geographic area of interest whereupon are plotted the locations of the one or more conforming lodging properties, wherein the map is initially displayed centered about an average location of the plotted lodging properties;
(d) plotting one or more non-lodging features on the map;
(e) providing a navigational control allowing the user to manipulate the map for viewing, wherein the navigational control includes a zoom capability and a movement capability;
(f) displaying in a pull-down dialog box substantially static information regarding a particular lodging property indicated by the user;
(g) displaying in the pull-down dialog box substantially dynamic information regarding the particular lodging property indicated by the user, wherein the substantially dynamic information is provided in substantially real-time so as to be substantially current;
(h) providing one or more hyperlinks to additional static information and additional dynamic information; and
(i) providing real-time access to a computerized reservation system of the particular lodging property indicated by the user so as to facilitate the user making a reservation.

27. A computer program operable to implement the method as set forth in claim 26.
